(19) United States
(12) Patent Application Publication
(10) Pub. No.: US 2026/0301773 A1
(43) Pub. Date: Oct. 1, 2026

(54) CROSS-DOMAIN TIMESTAMP ALIGNMENT FOR TIME-SENSITIVE DATA CORRELATION

(71) Applicant: Toshiba Global Commerce Solutions, Inc., Durham, NC (US)

(72) Inventors: Andrei Khaitas, McKinney, TX (US); Leonid Gonchar, Wysoka (PL); Sergey Novik, Kharkiv (UA); Illia Iorin, Wroclaw (PL); Andrey Pahomov, Kharkiv (UA)

(21) Appl. No.: 19/094,076

(22) Filed: Mar. 28, 2025

(51) Int. Cl. G11B 27/34; G06V 20/40; G06V 20/52; G06V 40/20

(52) U.S. Cl. CPC G11B 27/34; G06V 20/41; G06V 20/44; G06V 20/52; G06V 40/20

(57) ABSTRACT

Inventive concepts disclosed herein relate to systems, methods, and computer-readable media for synchronizing external event timestamps with video frame timestamps across distinct clock domains. In some implementations, an image capture device associates each video frame with a first timestamp derived from a local, monotonically increasing clock domain. A timestamp coordination system can add a second timestamp to each frame from a globally synchronized clock domain and can store the second timestamp in metadata. In some cases, external events are timestamped using the same second timestamp domain, and the timestamp coordination system can compare second timestamps with event timestamps to identify which video frames align with the corresponding events. The timestamp coordination system can select at least one of the video frames to associate with the event based on the comparison of the second timestamps with event timestamps.

### BACKGROUND

Computing environments that integrate data from multiple hardware or software components often rely on timestamps to establish temporal relationships among system activities. These timestamps may originate from distinct clock domains, such as local hardware clocks, operating system clocks, or network-synchronized time sources. Variations in oscillator precision, system latency, and clock correction mechanisms can introduce divergence between these time domains over time. As a result, timestamp drift may occur across independently operating components. In systems involving time-sensitive operations-such as sensor fusion, event tracking, or real-time analytics-such drift may affect the alignment of temporally related data. Examples include environments where imaging devices, sensors, and processing modules operate asynchronously but contribute to a common analytical context.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates a block diagram of a synchronization system for aligning video frame timestamps with external event timestamps in a computing environment.

FIG. 2 illustrates an example of frame-event misalignment and correct frame selection in a self-checkout environment.

FIG. 3 illustrates a flow diagram of a routine for synchronizing external event timestamps with video frame timestamps in a computing environment.

### DETAILED DESCRIPTION

In many computing environments, systems generate timestamped data across multiple components that operate on distinct time domains. For example, image capture devices may apply timestamps to video frames using a local, monotonically increasing clock, while external sensors or processing modules use independently synchronized clocks, such as those governed by network time protocols. Variations in oscillator frequency, processing latency, buffering delays, or synchronization updates can introduce drift between these time domains. Over time, this drift may result in misalignment between data sources, complicating efforts to associate events with their corresponding time-indexed records.

In configurations involving image capture, cameras typically assign timestamps to video frames using a local hardware clock, while external system events are often timestamped using a time reference that reflects global synchronization. Since these clocks are not inherently linked and may be subject to different correction mechanisms, their outputs can diverge. The resulting discrepancies can affect temporal alignment between frames and event data, especially when system components operate asynchronously or when synchronization protocols apply periodic corrections.

Some systems attempt to reconcile disparate clock domains through static offsets or linear interpolation functions. However, these approaches may be inaccurate when timing relationships vary non-linearly. Factors such as system load, buffering irregularities, and dynamic time adjustments can result in timestamp deviations that are not uniformly predictable. Consequently, assumptions of fixed or linearly scalable drift do not always yield consistent alignment across clock domains.

For example, in an automated retail checkout system, customers may scan items by moving them through a designated scanning area, while a camera captures video frames to detect the item's presence. Items may move at speeds of up to 3 meters per second, and the camera may operate at 60 frames per second, such that each frame represents approximately 0.05 meters of movement. Accurate temporal alignment is important to ensure that the selected frame corresponds to the moment when the item is fully within the scanning zone. Even minor timing discrepancies between the image capture device and an external sensor or scanning event may result in selecting a frame captured too early—before the item enters the zone—or too late—after the item has exited. Such frame selection errors can lead to missed scans, inaccurate item detection, incorrect pricing, or unnecessary rescans. In some cases, these inconsistencies may reduce the reliability and efficiency of the checkout process. By incorporating timestamping techniques that account for timing drift, processing delays, and asynchronous clock domains, the system can improve frame-to-event alignment and enhance real-time detection accuracy.

Some inventive concepts described herein relate to associating each video frame with a second timestamp derived from a system-wide synchronized time reference. The second timestamp may be based on a clock domain that reflects a globally consistent time source and is unaffected by local adjustments applied to device-specific clocks. In some cases, the synchronized time reference is maintained using an external time synchronization protocol, such as the Network Time Protocol (NTP). The synchronization process may involve an NTP server or client that distributes a common time reference across multiple systems or devices. The second timestamp can be embedded as metadata within each frame and propagated through the processing pipeline to maintain consistency. By incorporating this synchronized timestamp alongside the local device timestamp, the system can establish a common temporal reference that enables accurate alignment between independently clocked components. This approach reduces reliance on device-specific timing mechanisms, which may be subject to drift, adjustment anomalies, or inconsistencies in time progression across distributed hardware.

In some cases, synchronized timestamps are assigned at the point of frame exposure and propagated through the image processing pipeline. This approach can support accurate event-to-frame alignment across systems that rely on different clock domains. For example, multiple image capture devices can each generate synchronized timestamps that reflect a common time base, allowing temporal correlation between frames captured across devices.

In some cases, systems based on the Linux operating system may utilize platform-specific clock domains, such as CLOCK_MONOTONIC for device-local timestamps and CLOCK_MONOTONIC_RAW for timestamps that reflect a hardware-derived time reference not subject to NTP-based corrections. Although both clocks are monotonically increasing, they may diverge over time due to correction behaviors or clock drift. In such implementations, both clock values can be captured at the point of frame exposure and stored in metadata, enabling downstream processes to resolve discrepancies by referencing the synchronized value. While this example references Linux-specific clocks, analogous timing sources may be used in other environments to support consistent cross-domain alignment.

In some cases, a challenge in synchronized timestamping is that network time adjustments can occasionally introduce inconsistencies, where a newly assigned timestamp appears earlier than a previous frame's timestamp. This can occur, for example, when an external time synchronization protocol applies a sudden correction, causing an abrupt backward shift in time. Such anomalies can lead to misordered frames, disrupt event correlation, or introduce instability in systems that rely on a continuous progression of timestamps. To reduce the likelihood of these issues, some inventive concepts described herein can relate to a drift-based time correction method that modifies time adjustments such that they occur gradually rather than instantaneously. For example, instead of applying sudden step changes, the system can implement techniques such as time slewing, where adjustments can be distributed over a period to smooth out synchronization shifts. In some implementations, weighted averaging of multiple synchronization inputs can be used to further stabilize timestamp progression. In some cases, predictive filtering methods can be applied to anticipate expected variations in clock drift and introduce compensatory adjustments, which can help maintain a more stable and reliable synchronization signal across devices.

To reduce anomalies caused by abrupt time corrections-such as when network time synchronization causes a timestamp to regress-some inventive concepts described herein implement drift-based correction techniques. These techniques may include time slewing, weighted averaging, or predictive filtering, which allow timestamp adjustments to occur gradually and maintain monotonic progression.

In some implementations, a system can include multiple image capture devices, each operating with its own internal oscillator. Differences in oscillator frequencies across devices can accumulate over time, leading to variations in frame timing. For example, after capturing a large number of frames, these timing variations can result in misalignment between image streams. To mitigate this, inventive concepts described herein can be applied, where each frame from multiple image capture devices can be assigned a synchronized timestamp derived from a common time reference managed by an external synchronization protocol. By incorporating this synchronized timestamp into the metadata of each frame, the system can help improve temporal consistency between corresponding frames across different devices, even in the presence of timing variations.

Some inventive concepts described herein can improve video processing by addressing limitations of conventional timestamping methods. By embedding a system-wide synchronized timestamp into each frame and using it as a primary reference for temporal alignment, these techniques can improve the consistency of frame selection and synchronization across different devices. The disclosed approach can enhance precision in applications such as, but not limited to, automated scanning, security monitoring, industrial automation, and motion tracking systems, where maintaining reliable timing relationships between recorded data can contribute to improved system performance.

These synchronization techniques can be used in various contexts. For instance, they may support multi-camera coordination, frame stitching, or precise sequencing of distributed image capture. In some implementations, synchronization is applied between an image capture device and an event-generating peripheral, such as a barcode scanner or presence sensor. These implementations allow event-driven systems to associate sensor output with accurately aligned visual data.

Although the present disclosure generally refers to the use of synchronized timestamps for video frames in image capture devices, similar concepts could be applied in other contexts where precise timing relationships between recorded data may be important. For example, the techniques described herein may be used in lidar or depth-sensing systems to facilitate alignment between captured frames and spatial measurements. As another example, similar techniques may be applied in audio-visual synchronization, where multiple data streams, such as video and microphone input, need to be temporally aligned. In fields such as augmented reality (AR) and virtual reality (VR), synchronized timestamps can assist in merging real-world sensor inputs with generated graphics, improving user experience and interaction accuracy. Other applications include medical imaging, aerial surveillance, and/or autonomous vehicle navigation, where proper timing synchronization between different data sources can enhance decision-making and system performance.

The techniques described herein may be implemented in a variety of computing environments, including systems with centralized or distributed architectures, real-time or soft real-time processing requirements, and single or multi-device configurations. By embedding a globally synchronized timestamp within time-sensitive data, the inventive concepts enable more consistent correlation of asynchronous data streams, improve the reliability of temporal alignment, and enhance the precision of event-driven processing pipelines. These capabilities may be integrated into hardware-accelerated systems, software-controlled platforms, or hybrid architectures, supporting scalable deployment across diverse application domains.

Some inventive concepts described herein represent a notable improvement in the field of video processing and temporal synchronization, particularly in enhancing the accuracy and reliability of aligning image capture data with external timing references. By embedding a system-wide synchronized timestamp into video frames and utilizing this timestamp as a primary reference for alignment, these inventive concepts refine the approach to synchronizing image capture devices and event-driven systems. The disclosed techniques reduce reliance on device-specific timing mechanisms that may be susceptible to drift or inconsistencies, improving the accuracy of temporal correlation across distributed imaging systems. Additionally, by mitigating synchronization errors introduced by abrupt time adjustments and variations in clock domains, these techniques enhance the precision and consistency of frame selection and event matching. As a result, the disclosed approaches improve the practical application of video-based systems in dynamic environments, supporting advancements in automated scanning, security monitoring, industrial automation, and other time-sensitive imaging applications.

### Example Synchronization System

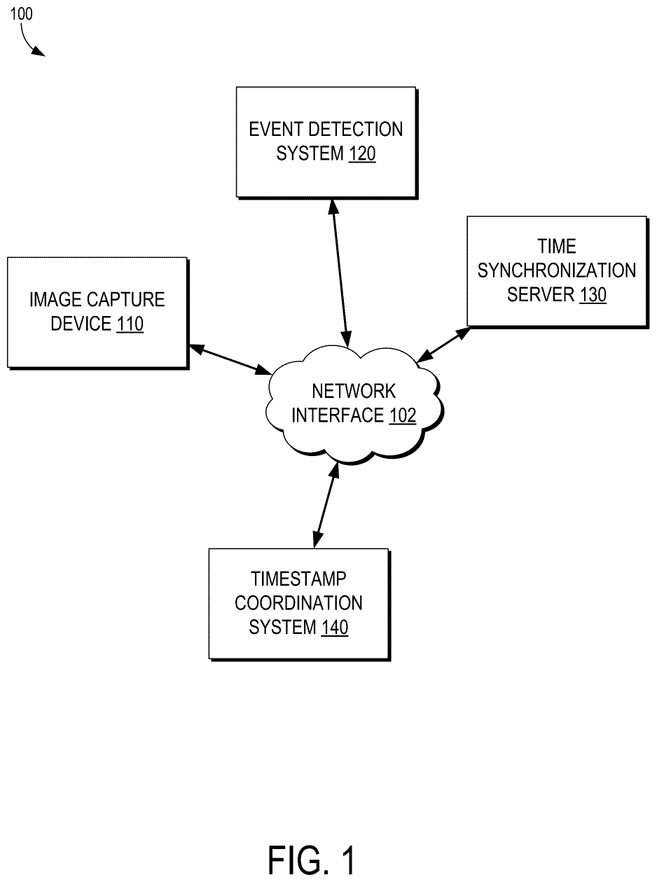

FIG. 1 illustrates a block diagram of a synchronization system 100 for aligning video frame timestamps with external event timestamps in a computing environment. The synchronization system 100 includes an image capture device 110, an event detection system 120, a time synchronization server 130, and a timestamp coordination system 140. To simplify discussion and not to limit the present disclosure, FIG. 1 illustrates only one instance of each component, though in some implementations, the synchronization system 100 may include multiple image capture devices 110, multiple event detection systems 120, or distributed instances of the time synchronization server 130 and the timestamp coordination system 140.

Any of the foregoing components can be connected via one or more network interfaces 102. The network interface 102 may include one or more communication channels capable of transmitting timestamped video data, event data, and synchronization messages. In some cases, the network interface 102 may support wired or wireless protocols, including Ethernet, Wi-Fi, Bluetooth, 5G, or combinations thereof. In implementations that employ time coordination across devices, the network interface 102 may also support transmission of messages based on an external time synchronization protocol, such as the Network Time Protocol (NTP) or the Precision Time Protocol (PTP). In some cases, the network interface 102 can support time synchronization traffic (e.g., NTP or PTP messages) in parallel with video, event, or metadata streams. For example, in a retail store, the network interface 102 may include a Wi-Fi mesh that connects overhead cameras, point-of-sale terminals, and an in-store server. In other implementations, high-precision fiber-based links may be used to synchronize robotic sensors across a manufacturing floor. In some cases, satellite-based systems or optical timing distribution may be used. The illustrated configuration is provided for explanatory purposes and does not limit the types or arrangements of networking infrastructure.

Each component of the synchronization system 100 may be implemented as a standalone hardware unit, a virtualized service, or a software module executing within a shared processing environment. In some cases, two or more components may reside on a shared platform. For example, the image capture device 110 and the event detection system 120 may reside on a point-of-sale terminal or kiosk, while the time synchronization server 130 may operate on a remote server or edge node. In other cases, distributed deployments may include edge-based image capture devices, network-connected detection sensors, and a cloud-hosted time synchronization service. In some implementations, some or all of the components can be located remotely from each other, communicating over a network to exchange timing and synchronization data. Furthermore, any of the foregoing components or systems can be combined and/or implemented using software, firmware, hardware, or any combination thereof to perform the functions described. Some implementations may distribute these components across a facility, a vehicle, or a data center.

The image capture device 110 may be configured to capture a plurality of video frames, each frame being assigned a first timestamp derived from a first clock domain. The first clock domain may represent a device-local hardware time source that advances monotonically and is not subject to external correction. For example, the first timestamp may be generated using CLOCK_MONOTONIC or a comparable system clock that provides a non-adjustable, continuously increasing time reference. In some cases, the first timestamp may be embedded in a frame header, stored in an associated metadata file, or included in a time-indexed buffer maintained by the device.

In some cases, the image capture device 110 may generate a first timestamp for each video frame using a local clock domain, and may transmit the frame to the timestamp coordination system 140 for additional processing. The timestamp coordination system 140 may be configured to obtain a second timestamp for each video frame based on a synchronized clock domain, such as CLOCK_MONOTONIC_RAW, sampled at or near the time of frame exposure. The second timestamp may be captured directly from a synchronized system clock or estimated based on a transformation model between the clock domains. The second timestamp may then be stored in association with the video frame, such as in a dedicated metadata field, a sidecar file, or a lookup structure maintained by the timestamp coordination system 140.

The image capture device 110 may transmit video frames and their associated timestamps to the timestamp coordination system 140. In some implementations, the image capture device 110 can be configured to operate in different frame rate modes, adjust exposure settings dynamically, or include multiple sensors that capture video across different wavelengths. In some cases, the image capture device 110 may support dynamic resolution control, exposure adaptation, or multi-spectral capture modes. For example, the image capture device 110 may be used in a retail setting, an industrial inspection line, or a warehouse environment, where precise timing is desired for event correlation.

In a retail example, the image capture device 110 may be mounted above a self-checkout lane or embedded in a checkout terminal to monitor customer interactions. The image capture device 110 can capture video frames as items move through a designated scanning area. Depending on the implementation, items may move at speeds of up to 3 (or more) meters per second, while the image capture device 110 can operate at a frame rate of 30, 60, or 120 frames per second, or another frame rate suitable for the application. For example, a 30 frames per second (FPS) camera may be used in standard checkout environments where moderate motion tracking is sufficient, while a 60 FPS or higher camera may be used in systems designed to track fast-moving objects with greater temporal precision. If an item moves at 3 meters per second and the device captures at 60 FPS, each frame may represent approximately 0.05 meters of movement. Accurate timing may enable the synchronization system 100 to determine whether an item was scanned when it was fully within a scan zone.

Each frame may represent a fraction of an item's movement, which can vary depending on the combination of item speed and frame rate. For example, if an item moves at 1 meter per second, and the image capture device 110 operates at 60 FPS, each frame can represent approximately 0.017 meters (1.7 cm) of movement. In a high-speed checkout system, where items may move at 3 meters per second, and the camera operates at 120 FPS, each frame can represent approximately 0.025 meters (2.5 cm) of movement. These relationships can be useful to help determine whether an item was properly scanned, placed into a bagging area, or removed from the scanning zone. As described herein, the synchronization system 100 can use timestamps to align video frames with events such as barcode scans, weight sensor detections, or RFID tag reads.

The event detection system 120 may be configured to detect external system events and generate corresponding event timestamps. These events may include physical interactions, mechanical state changes, environmental triggers, or other real-world activities that are observable and can be independently timestamped. As used herein, the term “external system event” may refer to an event that is generated independently of the image capture process, even if the event detection system 120 is co-located with or integrated into the same physical device as the image capture device 110. For example, such events may originate from barcode scanners, RFID readers, weight sensors, motion detectors, capacitive touch surfaces, acoustic sensors, or other components that operate on a distinct detection pathway or logic flow. In some cases, events may be triggered by hardware separate from the image capture device 110; in other cases, they may be detected by shared or adjacent hardware modules, provided that the video capture and event generation are initiated or processed independently.

The types of events detected may vary depending on the implementation domain. In retail environments, events may include product scans, item placements in a bagging area, customer interactions near a self-checkout kiosk, or removal of items without a corresponding scan. In industrial automation settings, the event detection system 120 may detect conveyor belt transitions, robotic actuation triggers, or quality control checkpoints. In security scenarios, events may include unauthorized access, tampering, or unexpected motion in restricted zones. In autonomous navigation or vehicle environments, detected events may include lane changes, object avoidance triggers, or pedestrian tracking. In medical or clinical settings, events may include biometric readings, patient movement, or procedural milestones such as dosage administration or surgical steps. In some cases, the event detection system 120 may infer a higher-level event based on input from multiple sensors, such as combining motion detection with pressure change to identify an object interaction.

Some or each detected event may be assigned an event timestamp based on a second clock domain, which may be synchronized across multiple devices using an external time synchronization protocol. In some cases, the event timestamp may be generated by reading a synchronized system clock at the time of event detection. In some cases, the timestamp may be assigned asynchronously or retrospectively based on a buffered sensor signal or system event log. The second clock domain may correspond to a synchronized time source such as CLOCK_MONOTONIC_RAW, and may be maintained by the time synchronization server 130. By using the same second clock domain as the one used for assigning synchronized timestamps to video frames, the event detection system 120 can help ensure consistent temporal correlation across devices and reduce alignment errors caused by clock drift or timing inconsistencies.

The event detection system 120 may transmit event data to the timestamp coordination system 140. The transmitted data may include the event timestamp and associated metadata that identifies the event type, originating sensor, detection conditions, or physical location. In some implementations, event data may be transmitted in real time using low-latency protocols. In other cases, data may be buffered and transmitted in batches for deferred analysis, recordkeeping, or system auditing. Metadata may include sensor identifiers, spatial coordinates, detection confidence values, device classifications, or event correlation tokens. The event detection system 120 may also apply filtering logic to eliminate noise or false positives, and may implement debouncing mechanisms to prevent duplicate detections from transient signals. In some implementations, alerts may be triggered based on the absence of an expected event—for example, if an object is removed from a monitored region without a corresponding scan or authentication. Event data may be used by downstream systems to support analytics, logging, behavioral modeling, or decision-making operations across distributed environments.

The time synchronization server 130 may be configured to provide a synchronized time reference for use by components within the synchronization system 100. In some cases, the time synchronization server 130 may operate as a Network Time Protocol (NTP) server or other time-distribution authority configured to maintain and broadcast a common time signal. The synchronized time reference may correspond to a system-level clock domain that advances monotonically and is not subject to application-level corrections. For example, in Linux-based environments, the synchronized time reference may align with CLOCK_MONOTONIC_RAW, which reflects the underlying hardware timer and excludes adjustments applied by time correction services.

The time synchronization server 130 may distribute synchronization data over the network interface 102. In some implementations, the time synchronization server 130 may itself obtain time from an upstream reference, such as a stratum-1 or stratum-2 NTP server, a GPS receiver, or an atomic time source. The time synchronization server 130 may then disseminate time information to downstream devices through periodic NTP messages or equivalent synchronization packets, which allow client devices to access or sample the synchronized time domain.

In some cases, the time synchronization server 130 may not directly assign or embed timestamps into data generated by other components. Instead, the time synchronization server 130 may operate as a passive time reference, providing access to a shared clock domain against which other systems may associate or reconcile time values. In particular, components such as the image capture device 110 and the event detection system 120 may generate local timestamps based on distinct clock domains, such as CLOCK_MONOTONIC. These timestamps may be decoupled from the synchronized time domain, resulting in clock drift or inconsistent timing alignment across the system.

In some implementations, the timestamp coordination system 140 may retrieve time values from the synchronized clock domain maintained by the time synchronization server 130 and use those values to associate or estimate second timestamps for video frames or external events. This may support cross-domain alignment between components that otherwise operate asynchronously. The time synchronization server 130 may provide the reference clock required for such alignment, but the responsibility for timestamp transformation, correction, or association may reside in the timestamp coordination system 140.

By maintaining a stable and globally consistent time domain, the time synchronization server 130 may support reduced drift and improved temporal correlation across independently clocked devices. For example, the synchronized time reference may allow the timestamp coordination system 140 to resolve timing discrepancies between a video frame captured using a hardware-local clock and an event timestamped using an operating system clock.

The timestamp coordination system 140 may be configured to support temporal alignment between video frames generated by the image capture device 110 and external events detected by the event detection system 120. In some implementations, the image capture device 110 may assign a first timestamp to each frame based on a local clock domain, such as CLOCK_MONOTONIC, while the event detection system 120 may assign timestamps to external events based on a synchronized clock domain, such as CLOCK_MONOTONIC_RAW. Because these two clock domains may diverge over time due to synchronization adjustments or hardware oscillator drift, alignment of frame and event timestamps may be inconsistent without additional processing.

The timestamp coordination system 140 may address this divergence by associating each video frame with a second timestamp derived from the synchronized clock domain. In some implementations, the second timestamp may be captured at or near the point of frame exposure by sampling both the local clock domain (CLOCK_MONOTONIC) and the synchronized clock domain (CLOCK_MONOTONIC_RAW). The timestamp coordination system 140 may receive both timing values from a driver, camera service layer, or middleware component that provides access to the respective time sources.

The timestamp coordination system 140 may store the synchronized timestamp in association with the corresponding video frame using one or more techniques. In some implementations, the timestamp coordination system 140 may embed the synchronized timestamp into a metadata field within the frame buffer. In other implementations, the timestamp coordination system 140 may store the synchronized timestamp in a lookup table indexed by frame identifier, sequence number, or memory address. In either case, the association of a second timestamp with each video frame may support downstream processing components that operate on a shared timebase.

In scenarios where the image capture device 110 provides only a timestamp based on the local clock domain, the timestamp coordination system 140 may estimate the corresponding synchronized timestamp using a clock-domain transformation model. The transformation model may be constructed from previously observed pairs of local and synchronized clock values, and may include linear or non-linear interpolation, drift correction, or extrapolation based on recent system behavior. The transformation model may be updated periodically to reflect variations in synchronization state.

To reduce the likelihood of anomalies resulting from abrupt corrections applied to the synchronized clock domain—such as those introduced by the Network Time Protocol (NTP)—the timestamp coordination system 140 may apply smoothing or correction techniques to maintain monotonicity of synchronized timestamps across frames. In some implementations, the timestamp coordination system 140 may apply time slewing, weighted averaging, or filtering techniques to moderate changes in the synchronized clock domain and reduce disruptions in timestamp ordering.

Once a synchronized timestamp is associated with each video frame, the timestamp coordination system 140 may compare the synchronized timestamp to event timestamps received from the event detection system 120. Because both sets of timestamps may be derived from the same synchronized clock domain, direct comparison may be performed to determine temporal proximity. In some cases, the timestamp coordination system 140 may compute a time difference between each frame and the event and may identify the frame with the smallest difference for use in subsequent processing.

In applications that involve fast-moving objects or require fine-grained temporal resolution, the timestamp coordination system 140 may apply additional logic to filter or prioritize candidate frames. For example, the timestamp coordination system 140 may exclude frames that fall outside a predefined temporal window relative to an event timestamp or may apply a domain-specific rule set to select a frame based on expected object motion or sensor activation timing.

In environments that include multiple image capture devices 110, the timestamp coordination system 140 may assign synchronized timestamps to frames originating from each device based on a common clock domain. This may allow frames captured by multiple devices to be aligned in time, supporting coordinated video analysis, multi-angle reconstruction, or synchronized sensor fusion across spatially distributed systems.

The timestamp coordination system 140 may be implemented as a standalone software service, a component of a middleware framework, or a process operating on a shared edge computing node. The timestamp coordination system 140 may provide interfaces for receiving frame metadata, accessing synchronized timestamps, and performing time-based frame selection in response to external inputs. Deployment may vary based on application latency constraints, data volume, or system architecture.

By associating each video frame with a synchronized timestamp derived from a common clock domain, and by applying transformation and correction logic to account for drift and discontinuities, the timestamp coordination system 140 may support more consistent alignment between video data and independently timestamped external events. This may contribute to improved correlation accuracy in systems that include asynchronous sensing components, such as automated checkout systems, surveillance platforms, or industrial monitoring environments.

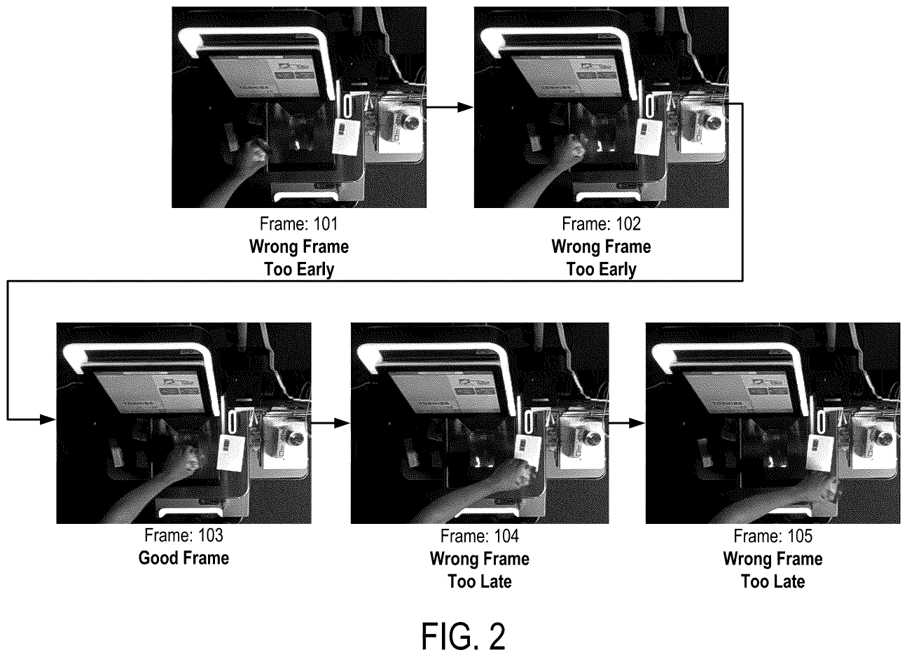

FIG. 2 illustrates an example of frame-event misalignment and correct frame selection in a self-checkout environment. The synchronization system 100 includes an image capture device 110 configured to capture video frames as a customer moves an item through a scan region. The event detection system 120 detects the item's barcode scan and generates a corresponding event timestamp. Because the image capture device 110 and the event detection system 120 operate asynchronously and may rely on distinct clock domains, frame-event alignment may be affected by timing drift or system latency.

In FIG. 2, five consecutive frames (Frames 101-105) are captured by the image capture device 110. Each frame is initially timestamped using a local clock domain (CLOCK_MONOTONIC) and is subsequently associated with a synchronized timestamp (CLOCK_MONOTONIC_RAW) by the timestamp coordination system 140. The event detection system 120 generates an event timestamp at the moment the barcode scanner detects the item. The timestamp coordination system 140 selects the frame with the closest synchronized timestamp to the event timestamp.

In the illustrated sequence, Frame 103 represents the correct frame, in which the item is fully within the scan zone and actively engaged in the scanning process. Frames 101 and 102 are captured too early, before the item enters the scan region, while Frames 104 and 105 are captured too late, after the item has exited. If a conventional system were to align frames based only on local timestamps (CLOCK_MONOTONIC), clock drift or timing misalignment may result in incorrect frame selection. For instance, the system might mistakenly associate the event timestamp with Frame 102 (too early) or Frame 104 (too late), leading to inaccurate product recognition, missed barcode scans, or improper transaction processing.

The timestamp coordination system 140 improves selection accuracy by associating each video frame with a synchronized timestamp and comparing event timestamps in the same clock domain. By referencing the synchronized timestamp (CLOCK_MONOTONIC_RAW), the timestamp coordination system 140 determines that Frame 103 is the most temporally aligned with the event timestamp. This ensures that the system correctly associates the barcode scan with the visual frame in which the item was scanned, thereby improving transaction accuracy and reducing the likelihood of missed detections or false scans.

In some implementations, the timestamp coordination system 140 may additionally store metadata associated with the selected frame, such as a frame identifier, event correlation data, or confidence values. This information may be used for downstream processing, such as validating transactions, generating audit logs, or triggering additional processing steps (e.g., re-scanning or fraud detection). The principles illustrated in FIG. 2 may also be applied to other domains, including industrial automation, security monitoring, and autonomous navigation, where accurate event-to-frame alignment is necessary for high-precision decision-making.

### Example Implementation

The following example illustrates an implementation of the synchronization system 100 operating in a self-checkout retail environment. In this case, the synchronization system 100 includes an image capture device 110 configured to capture video frames at a frame rate of 60 frames per second (FPS), producing a new frame approximately every 16.67 milliseconds. Each video frame is initially timestamped using a first clock domain based on a device-local hardware timer (e.g., CLOCK_MONOTONIC). The image capture device 110 transmits each frame and its local timestamp to the timestamp coordination system 140 for further processing.

The timestamp coordination system 140 is configured to associate a second timestamp with each video frame, derived from a synchronized clock domain (e.g., CLOCK_MONOTONIC_RAW). This synchronized timestamp may be captured directly at frame exposure or inferred using a transformation model. The synchronized timestamp is stored as metadata associated with the frame. External system events—such as barcode scans—are detected by the event detection system 120 and assigned event timestamps based on the same synchronized clock domain. The time synchronization server 130 maintains the synchronized time reference and distributes it to other system components using the Network Time Protocol (NTP).

In this example, a customer moves an item through a scanning zone. The image capture device 110 captures Frame 6 at a local time of 1083.33 ms. At the same moment, the event detection system 120 records a barcode scan with a synchronized timestamp of 1095.00 ms. However, due to oscillator drift, the local time used by the image capture device 110 is ahead of the synchronized time. At Frame 6, the system has accumulated a +12 ms drift between the local and synchronized clock domains.

Table 1 illustrates the mapping between local and synchronized timestamps for each frame, and the timing of the external barcode scan event. In a conventional system without the timestamp coordination system 140, the local timestamp (CLOCK_MONOTONIC) might be used directly for alignment with the event timestamp (CLOCK_MONOTONIC_RAW), which may result in a mismatch.

TABLE 1
Dual Timestamps Per Frame and Event Timing

| | Local Timestamp | Synchronized Timestamp | Event |
|---|---|---|---|
| Frame | (CLOCK_MONOTONIC) | (CLOCK_MONOTONIC_RAW) | Timestamp |
| # | [ms] | [ms] | [ms] |
| 1 | 1000 | 1002 | — |
| 2 | 1016.67 | 1019 | — |
| 3 | 1033.33 | 1036 | — |
| 4 | 1050 | 1053.33 | — |
| 5 | 1066.67 | 1071 | — |
| 6 | 1083.33 | 1093 | 1095.00 (Scan) |
| 7 | 1100 | 1109 | — |

In a conventional implementation, frame-to-event matching may be based on comparing the event timestamp to the local timestamp of the video frames. Because Frame 6 is timestamped at 1083.33 ms (local time), the nearest local time greater than 1095.00 ms is Frame 7, which has a local timestamp of 1100.00 ms. As a result, the system may incorrectly associate the barcode scan with Frame 7. However, Frame 7 captures the item after it has exited the scan zone, leading to a missed detection or a classification error.

In contrast, the timestamp coordination system 140 correctly associates Frame 6 with a synchronized timestamp of 1093.00 ms, which is closer to the barcode scan event timestamp of 1095.00 ms. Because both timestamps exist in the same synchronized clock domain, the timestamp coordination system 140 performs an accurate temporal comparison and selects Frame 6 for further analysis. This allows the system to associate the event with the correct frame in which the item is fully present within the scan zone.

To preserve timestamp monotonicity and reduce disruptions caused by abrupt synchronization corrections (e.g., step changes from NTP), the timestamp coordination system 140 applies a drift-aware compensation mechanism. Rather than immediately applying a −12 ms correction at Frame 6, the system gradually adjusts synchronized timestamps across multiple frames, distributing the correction over time.

### Timestamp Synchronization in a Video Processing Environment

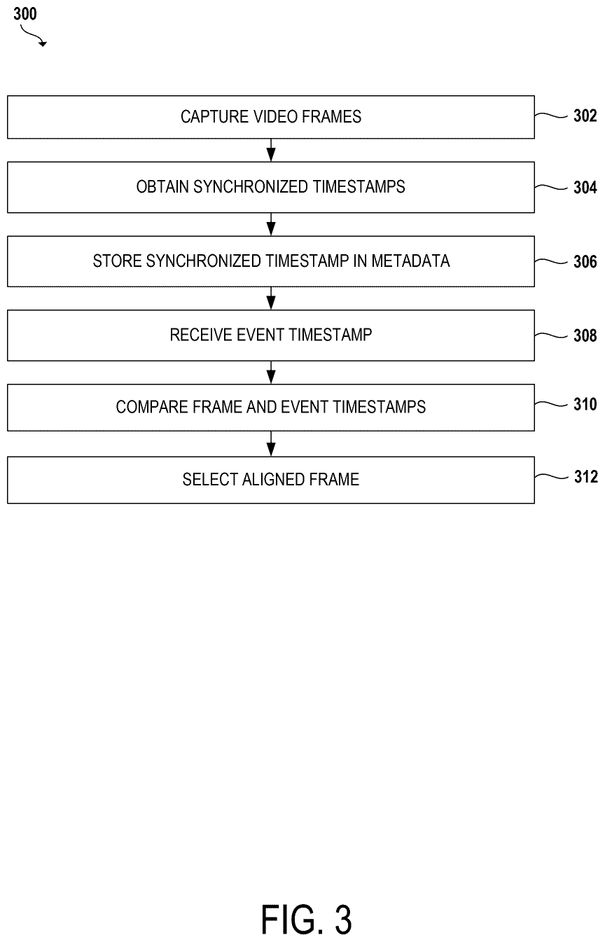

FIG. 3 illustrates a flow diagram of a routine 300 for synchronizing external event timestamps with video frame timestamps in a computing environment. In some implementations, the routine 300 may be performed by or in conjunction with a timestamp coordination system configured to interface with an image capture device, an external event detection system, and/or a time synchronization server, such as those of FIG. 1. It will be appreciated that, depending on the embodiment, the routine 300 may include additional, fewer, or different steps.

At block 302, the image capture device captures a plurality of video frames, each video frame being assigned a first timestamp derived from a first clock domain. In some cases, the first clock domain offers a monotonically increasing, non-adjustable time reference local to the image capture device.

At block 304, the timestamp coordination system 140 assigns a second timestamp to each video frame. For example, the timestamp coordination system 140 may receive or request these frames from the image capture device. The second timestamp can be derived from a second clock domain that may be synchronized across multiple devices by an external time synchronization protocol, such as NTP. By referencing the second clock domain, the timestamp coordination system 140 can mitigate discrepancies in time, such as those introduced by oscillator variances or abrupt time corrections that might occur in the local clock domain.

At block 306, the timestamp coordination system 140 embeds or stores the second timestamp within metadata associated with the corresponding video frame. In some cases, this metadata may reside in a dedicated field of the frame header or in a separate data structure that remains linked to the frame throughout the processing pipeline. Storing synchronized timestamps in each frame's metadata allows downstream modules (e.g., analytics services or computer vision algorithms) to reference a consistent time domain when correlating frames to external events.

At block 308, the external event detection system generates an event timestamp that may be derived from the second clock domain. For instance, in a retail environment, a barcode scanning device or sensor might record an event. The timestamp coordination system 140 then receives this second clock domain event timestamp for comparison against the second timestamps embedded in the video frames.

At block 310, the timestamp coordination system 140 locates the video frame aligned with the event timestamp in a globally consistent timeline. In some cases, the timestamp coordination system 140 identifies the frame whose second timestamp has the smallest absolute difference from the event timestamp, for example by comparing a sorted list of frame timestamps or evaluating each frame sequentially. Selecting the frame that most closely matches the moment of the detected event can help confirm whether an item was scanned while in view, detect anomalous activity, or verify that a product was correctly associated with its transaction record. In some cases, the timestamp coordination system 140 may choose the last frame whose second timestamp precedes the event timestamp. Alternatively, in some cases, the timestamp coordination system 140 may select the first frame whose second timestamp follows the event timestamp. Such configurable frame-selection criteria can be especially valuable in dynamic environments. In a retail setting, for instance, one use case may be verifying that a product was in the scanning zone at the precise moment of a barcode read (closest frame), while another use case may involve detecting whether a customer removed an item from a shelf without scanning (the frame immediately after the event). By supporting multiple alignment strategies—closest, last before, or first after—the timestamp coordination system 140 can adapt to a variety of operational requirements, reduce false positives or missed scans, and improve the accuracy of downstream analytics.

At block 312, the timestamp coordination system 140 designates a particular frame (or set of frames) from among the plurality of frames as corresponding to the external event. The selected frame may then be forwarded to a downstream process, such as an automated checker, a computer vision analysis routine, or a security logging service. This selection mechanism reduces the likelihood of error that can arise when only local timestamps are used, especially in the presence of clock drift or sudden synchronization corrections.

In some implementations, the timestamp coordination system 140 may additionally apply drift-mitigation strategies if the external time synchronization protocol introduces incremental corrections to the synchronized clock domain. Rather than overwriting previously stored second timestamps, the timestamp coordination system 140 can track incremental offsets or drift values to maintain a monotonically increasing time reference across frames. This helps avoid retroactive shifting of timestamps, which could otherwise create inconsistencies for downstream analytical services that rely on stable temporal progression.

Although illustrated as a sequence of discrete blocks, FIG. 3 may represent one of various possible flows. For instance, some implementations may add additional steps, such as sampling transformation matrices between the first and second clock domains or storing multiple synchronized timestamps at varying levels of precision. Other implementations may consolidate certain steps, such as if multiple image capture devices share a unified synchronization policy.

### Terminology

It is understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this present disclosure may include, additional to its essential features described herein, one or more features as described herein from each other embodiment of the present disclosure disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in various combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some cases, the actual steps taken in the processes illustrated and/or disclosed may differ from those shown in the figures. In at least some examples, the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey cases include, while other embodiments do not include, features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain cases require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for synchronizing external event timestamps with video frame timestamps in a computing environment, the method comprising:
capturing a plurality of video frames via an image capture device, each video frame being associated with a first timestamp derived from a first clock domain that provides a monotonically increasing, non-adjustable time reference local to the image capture device;
assigning, to each video frame, a second timestamp derived from a second clock domain, wherein the second timestamp is synchronized across multiple devices via an external time synchronization protocol and stored as metadata within a corresponding video frame;
receiving an event timestamp associated with an external system event, wherein the event timestamp is generated based on the second clock domain and shares a common synchronization source with the second timestamp of the video frames; and
selecting a video frame from the plurality of video frames based on a comparison between the second timestamp of the video frames and the event timestamp.

2. The method of claim 1, wherein selecting the video frame comprises determining the video frame whose second timestamp has a smallest difference from the event timestamp.

3. The method of claim 1, wherein the external time synchronization protocol adjusts time corrections using a gradual slewing mechanism.

4. The method of claim 1, wherein the image capture device is part of a real-time retail tracking system, and the external system event corresponds to a barcode scanning event, a product interaction, or a customer movement event detected by an external sensor.

5. The method of claim 1, wherein the selected video frame is used to track an object or individual within a retail environment by associating the selected video frame with the external system event, the external system event indicating an interaction with a product, movement within a defined area, or an attempted transaction.

6. The method of claim 1, wherein the selected video frame is processed by another system to determine whether an item has been scanned, left unscanned, or otherwise removed from a designated retail area without authorization.

7. The method of claim 1, wherein the selected video frame is analyzed using computer vision algorithms to classify customer behavior, detect suspicious activity, or generate alerts based on predefined behavioral patterns.

8. The method of claim 1, wherein the second timestamp is stored in a dedicated metadata field within each video frame, accessible by downstream processing components.

9. The method of claim 1, further comprising updating the second timestamps of at least some of the video frames based on corrections received from the external time synchronization protocol to compensate for drift between the first clock domain and the second clock domain.

10. The method of claim 1, wherein the external time synchronization protocol comprises a Network Time Protocol (NTP).

11. The method of claim 1, wherein the second timestamp is retrieved from a hardware-based clock source that is independent of software-driven system time adjustments.

12. The method of claim 1, wherein the second timestamp is assigned to each video frame in a system comprising multiple image capture devices, wherein the second timestamps are synchronized across the multiple image capture devices via the external time synchronization protocol to mitigate timing discrepancies caused by independent oscillator variances.

13. The method of claim 1, further comprising detecting and correcting accumulated drift between video frames captured by separate image capture devices based on the second timestamps, wherein drift is calculated as a difference in expected frame timing across the multiple devices.

14. The method of claim 1, wherein time corrections applied via the external time synchronization protocol prevent abrupt backward adjustments to the second timestamps by implementing a time slewing mechanism that ensures continuous forward progression of timestamp values.

15. The method of claim 1, further comprising:
capturing a plurality of video frames from a second image capture device;
assigning, to each video frame of the second image capture device, a second timestamp derived from the second clock domain, wherein the second timestamp is synchronized between the first image capture device and the second image capture device via the external time synchronization protocol according to a synchronization policy; and
temporally aligning at least some of the video frames from the first image capture device and the second image capture device based on their respective second timestamps.

16. A system for synchronizing external event timestamps with video frame timestamps, the system comprising a timestamp coordination system that is configured to:
access data indicative of a plurality of video frames, each video frame having a first timestamp derived from a first clock domain that provides a monotonically increasing, non-adjustable time reference;
obtain a second clock domain that is synchronized across multiple devices via an external time synchronization protocol;
assign, to each video frame, a second timestamp derived from the second clock domain, wherein the second timestamp is stored in metadata associated with the video frame;
receive an event timestamp associated with an external system event, the event timestamp being generated based on the second clock domain; and
select at least one of the video frames for correlation with the external system event based on a comparison between the second timestamp of the video frames and the event timestamp.

17. The system of claim 16, wherein the timestamp coordination system is further configured to embed the second timestamp in a dedicated metadata field within each video frame, the dedicated metadata field being accessible to one or more downstream analytics modules to enable frame-to-event correlation across asynchronous system components.

18. The system of claim 16, wherein the timestamp coordination system is further configured to detect drift conditions in the second clock domain resulting from adjustments by the external time synchronization protocol, and to apply incremental compensation to preserve monotonicity of the second timestamps across successive frames.

19. The system of claim 16, wherein the external time synchronization protocol comprises a Network Time Protocol (NTP).

20. A non-transitory computer-readable medium storing instructions that, when executed by one or more processors, cause a timestamp coordination system to:
access data indicative of a plurality of video frames, each video frame having a first timestamp derived from a first clock domain that provides a monotonically increasing, non-adjustable time reference;
obtain a second clock domain that is synchronized across multiple devices via an external time synchronization protocol;
assign, to each video frame, a second timestamp derived from the second clock domain, wherein the second timestamp is stored in metadata associated with the corresponding video frame;
receive an event timestamp associated with an external system event, the event timestamp being generated based on the second clock domain; and
select at least one of the video frames for correlation with the external system event based on a comparison between the second timestamp of the video frames and the event timestamp.
